(19) United States
(12) Patent Application Publication
(10) Pub. No.: US 2025/0298295 A1
(43) Pub. Date: Sep. 25, 2025

(54) Modular Mount With Drop-Down Arm For Video, Audio and Lighting Equipment

(71) Applicant: Anthony James Franco, Monrovia, CA (US)

(72) Inventor: Anthony James Franco, Monrovia, CA (US)

(21) Appl. No.: 19/086,568

(22) Filed: Mar. 21, 2025

Related U.S. Application Data
(63) Continuation-in-part of application No. 18/612,206, filed on Mar. 21, 2024.

(51) Int. Cl. G03B 17/56; G08B 13/196

(52) U.S. Cl. CPC G03B 17/561; G08B 13/19632

(57) ABSTRACT

A modular mount for mounting a video cameras and other equipment to a wall, including a base assembly, that includes a wall bracket used to attach the modular mount to a wall, and a primary tube, attached to the wall bracket; and a head assembly, attached to the second end of the secondary tube, an arm assembly attached to the underside of the pan which projects vertically downward from the pan, that includes an upper coupler that attaches the arm assembly to the underside of the pan, an arm that drops downward from the pan, and a lower coupler that attaches the arm assembly to a camera assembly; and a camera assembly that includes a housing that attaches to the lower coupler, to which a camera and any other equipment mounts.

### BACKGROUND OF THE INVENTION

Over the past twenty years the commercial security industry has experienced widespread adoption of video surveillance systems. Video surveillance systems assist companies to evaluate worker compensation claims, provide real-video monitoring of physical premises and track inventory loss. Video surveillance is especially beneficial in fulfillment centers and shipping hubs due to the increase in shipping volumes.

Historically, the most feasible solution for loading dock surveillance involved suspending cameras from industrial building roofs. For example, in some applications a video camera is mounted on an electrical box looking in the general direction of a loading docks. These video cameras are generally mounted 15-20 feet high to avoid interference with the forklifts as they pass by.

However, such an approach has multiple problems, such as that (1) technicians typically need to use a ladder or lift every time the camera needs to be serviced or repositioned, and (2) the cameras are mounted too high to capture detailed footage within trailers, where most inventory discrepancies and safety incidents occur.

A modular mount is described in U.S. patent application Ser. No. 18/612,206, filed on Mar. 21, 2024, also by Anthony James Franco, which is hereby incorporated by reference in its entirety. The Application describes a modular mount with a hinged head that swings outward when struck and then returns to the original position. The hinge allows for movement in a single direction.

### SUMMARY OF THE INVENTION

The subject invention is a modular mount that may be used to mount a video camera and other devices such as a light or speaker to a wall or ceiling of a building. For example, the modular mount may be used to mount a video camera and a light to a wall in a loading bay to capture uninterrupted footage of loading dock activities. The modular mount offers multiple size settings to position the camera, thus enabling it to be positioned out of range of forklifts or other equipment. The modular mount is especially intended for use in loading docks or other facilities that have swinging container doors.

The position of the modular mount in relation to a wall, beam or other mounting location may be adjusted to fit specific installation requirements and then locked into place. Wiring for cameras, barcode scanners, lights, or speakers is routed through designated channels within the frame. A novel feature of the modular mount is that it includes a drop-down arm with a joint or spring mechanism that maintains optimal camera positioning even when impacted physically, such as being struck by a forklift.

In certain embodiments, the modular mount includes a drop-down arm with a joint that enables an attached camera housing to move away away from its standard position when it is pushed or knocked against in order to absorb the impact. The joint is typically a spring or universal joint which returns to its original position after impact. Other types of joints may also be used.

In certain embodiments, the invention is a modular mount for mounting a video cameras and other equipment to a wall, including (1) a base assembly, including a wall bracket used to attach the modular mount to a wall, and a primary tube, attached to the wall bracket, (2) a head assembly, including a secondary tube that fastens to the primary tube, and a head, attached to the secondary tube, (3) an arm assembly that drops, or projects, down from the head assembly, and (4) a camera assembly attached to the arm assembly enabling a video camera and any other equipment to mount to the underside of the camera assembly.

In yet other embodiments, the invention is a modular mount for mounting a video cameras and other equipment to a wall, including a base assembly, that includes a wall bracket used to attach the modular mount to a wall, and a primary tube, attached to the wall bracket; and a head assembly, attached to the second end of the secondary tube, an arm assembly attached to the underside of the pan which projects vertically downward from the pan, that includes an upper coupler that attaches the arm assembly to the underside of the pan, an arm that drops downward from the pan, and a lower coupler that attaches the arm assembly to a camera assembly; and a camera assembly that includes a housing that attaches to the lower coupler, to which a camera and any other equipment mounts.

### BRIEF DESCRIPTION OF DRAWINGS

Non-limiting and non-exhaustive embodiments of the present invention are described with reference to the following drawings. In the drawings, like reference numerals refer to like parts throughout the various figures unless otherwise specified.

FIG. 1A is a front view of an embodiment of a modular mount that is mounted on the wall of a loading dock.

FIG. 1B is a top view of the modular mount being used to monitor a forklift that is moving a container.

FIG. 2A is an isometric view of the modular mount, shown disassembled.

FIG. 2B is an isometric view of an embodiment of the modular mount, shown in a disassembled state where the housing lid is open.

FIG. 3A illustrates an arm assembly 300, which is an embodiment of the arm assembly depicted in FIG. 2A.

FIG. 3B illustrates an arm assembly 350, which is another embodiment of the arm assembly depicted in FIG. 2A.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE INVENTION

The invention is described hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, or devices. The following detailed description is, therefore, not to be taken in a limiting sense.

The modular mount enables a camera, light, speaker, or other device to mount on the wall of a loading bay or dock, or wall. Typically, the mounted device performs video or audio surveillance. For example, the mounted device may fasten in the top corner of a wall of a loading bay to capture uninterrupted footage of loading dock activities. The modular mount may be included in a surveillance system used to protect business owners and employees by documenting through video and/or audio movement of goods, and the various activities associated with loading and unloading goods from trailers and containers. The modular mount offers multiple size settings to position the camera out of range of forklifts and to avoid swinging container doors.

As used herein the following terms have the meanings given below:

Joint—as used herein refers to a mechanism that enables a camera or another device attached to the joint to return to its original position after being struck. Mechanisms that for purposes herein can be considered as joints include inter alia springs, universal joints, also referred to as U-joints, or Cardan or Cardano joints, and hinges.

### Operational View of the Modular Mount

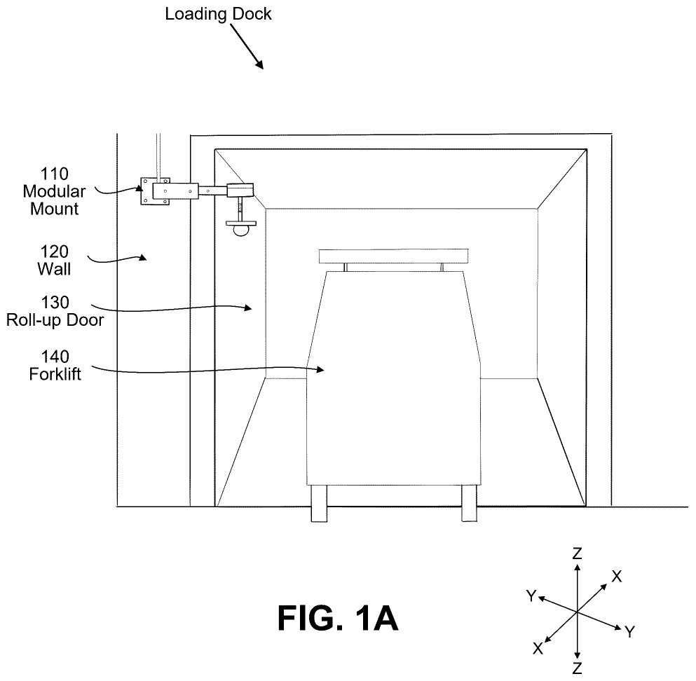

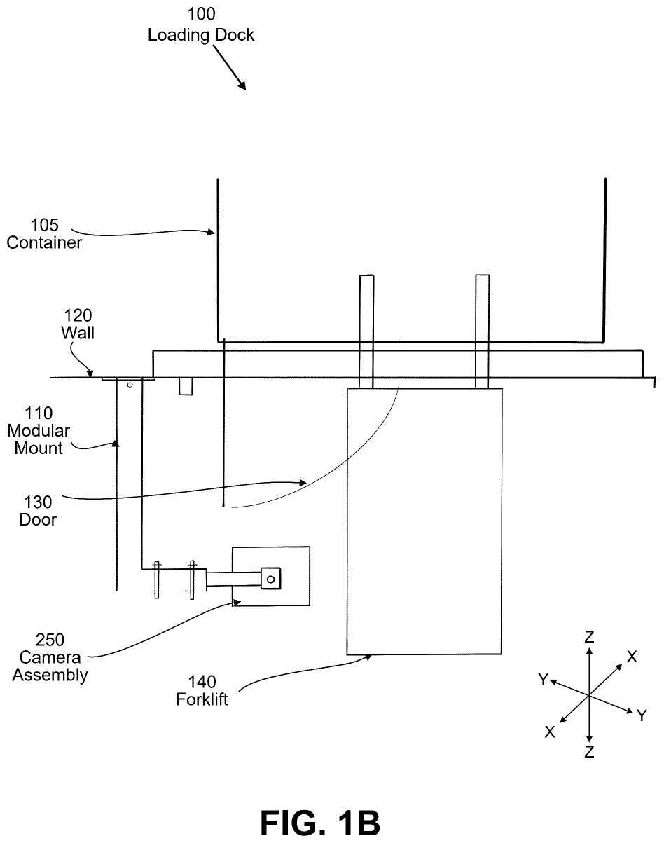

FIGS. 1A and 1B are two views of a modular mount 110 that is mounted on a wall 120 in a loading area. In each view, modular mount 110 cantilevers outward from a wall 120 to which it mounts towards a forklift 140.

FIG. 1A is a front view of an embodiment of modular mount 110 that is mounted, or attached, to wall 120 of a loading dock 100. Wall 120 is between adjacent roll-up doors 130. Alternatively, modular mount 110 may be mounted on a flat surface such as inter alia a post, a beam, and a panel. In this embodiment, as depicted in FIG. 1A, modular mount 110 is cantilevered towards the opening of roll up door 130 in the direction of forklift 140, enabling it to avoid the roll up door track and frame as well as any inward swinging container doors. Modular mount 110 is depicted as providing a camera, pointing downward. Generally, modular mount 110 can mount or house a broad range of electrical fixtures including, inter alia, video cameras, still cameras, lights, microphones and speakers. Based on the selection of the camera (video or still) and the positioning of modular mount 110 the camera can have a very wide field of view, typically from 180 to 360 degrees.

FIG. 1A also depicts the three-dimensional coordinate system used herein. The Z dimension value refers to the height from the floor or ground. The Y dimension is the distance away from wall to which modular mount 110 is attached, essentially a distance perpendicular to the plane of the wall. The X dimension refers to the distance from the mounting location along the wall, or along an imaginary line parallel to the wall.

FIG. 1B is a top view of modular mount 110 being used to monitor a forklift 140 that is moving a container 105. In this example, a camera assembly 250 to which a camera attaches monitors the movements of forklift 140 and container 105.

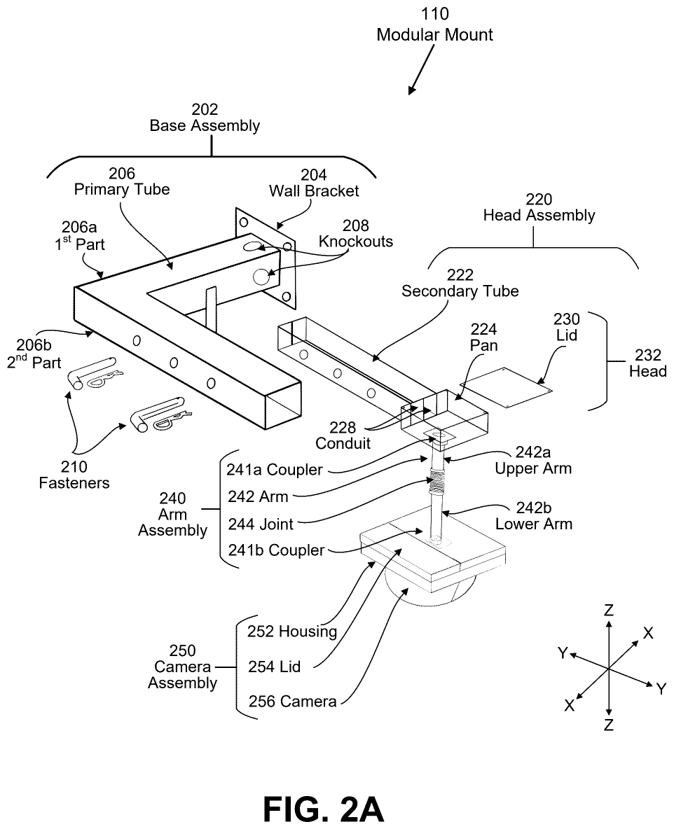

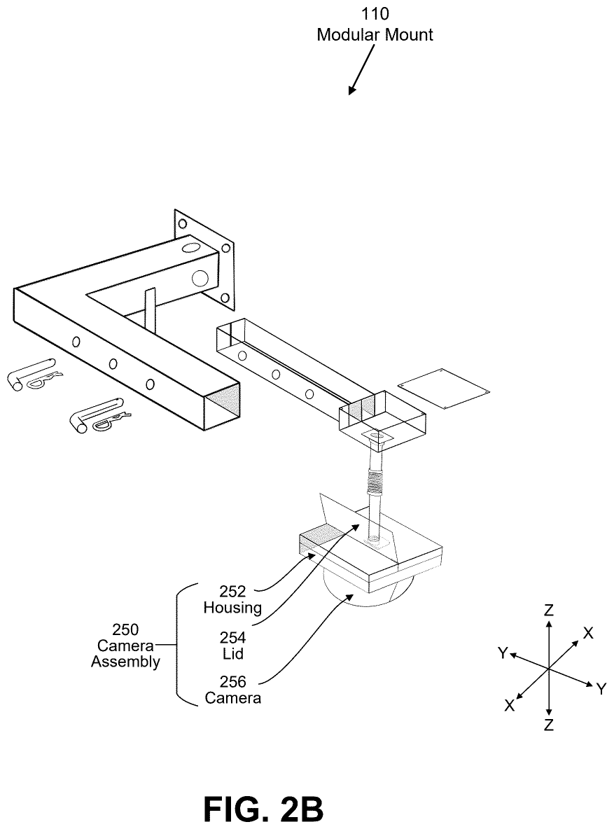

FIG. 2A is an isometric view of an embodiment of modular mount 110, shown in a disassembled state. Here modular mount 110 is shown disassembled into four interlocking assemblies: base assembly 202, head assembly 220, arm assembly 240 and camera assembly 250. This configuration enables easy shipping and assembly. In other embodiments, modular mount 110 may be provided as a single, fully assembled, unit. While in other embodiments, when disassembled, modular mount 110 may be in two or more pieces.

Base assembly 202 includes a wall bracket 204, used to attach modular mount to a wall or other surface, and a primary tube 206. Typically wall bracket 204 includes holes for attaching mount 110 to a wall using screws. Alternatively, another attachment mechanism may be used to attach wall bracket 204 to a surface. In certain embodiments, wall bracket 204 is a 2.5″ commercial metal bracket, suitable for connecting a 2.5″ square pipe, referred to herein as a tube.

Primary tube 206 connects to wall bracket 204 through a weld or other fastening mechanism. In certain embodiments, primary tube 206 is L-shaped, that is it includes a 90 degree angle, where (1) a 1^{st} part 206a of primary tube 206 attaches to wall bracket 204, and when modular mount 110 is mounted on the wall 2^{nd} part 206a extends in the Y direction perpendicular to the wall, and (2) a 2^{nd} part 206b that forms a 90 degree angle with 1^{st} part 206a and, when modular mount 110 is mounted on the wall, extends in the X direction parallel to the wall. This geometry enables camera assembly 250 to be positioned at a desired distance from wall bracket 204 in the X, Y, and Z directions.

For commercial reasons, base assembly 202 is provided in a variety of sizes and lengths. Tube sizes are typically 2 inches or 2.5 inches. Length of the tube first part is typically. 5-3 feet and lengths of the tube second part are typically 1-6 feet. Other tube sizes and lengths are possible. Further, while tubes are depicted as square in each of the figures herein, rectangular, circular, diamond shaped, or other shaped tubing can be used without departing from the scope of the invention.

At the base of primary tube 206, close to its attachment to wall bracket 204, are one or more knockouts 208, which are typically used as conduit for electrical lines. Knockouts 208 are typically used for low voltage camera/speaker wire and 110V wire for lighting Typically, there are at least two knockouts 208 enabling speaker and camera/speaker to be separated.

A secondary tube 222, attached to pan 224, attaches to primary tube 206, thus connecting head assembly 220 to base assembly 202. In one embodiment, secondary tube 222 fits inside primary tube 206 and the two tubes attach using fasteners 210 that fit through pre-drilled holes in both primary tube 206 and secondary tube 222. During assembly, secondary tube 222 is inserted inside primary tube 206 until one or more of the pre-drilled holes in each tube is aligned and then a fastener, such as a locking pin, is inserted and secured through each pair of aligned holes. Secondary tube 222 can be inserted fully inside primary tube 206 in which case pan 224 is flush or nearly flush with the end of primary tube 206, at the end opposite the end that attaches to wall bracket 204. Alternatively, secondary tube 222 may be only partially inserted inside primary tube 206. In other embodiments, primary tube 206 may be inserted inside secondary tube 222.

A pan 224 attaches to one end of secondary tube 222, from the end that extends outward from primary tube 206 2^{nd} part 206b. Pan 224 is used to attach arm assembly 240, which in turn attaches to camera assembly 250. Pan 224 enables any wiring, e.g. camera, lighting and network connections, to travel into secondary tube 222 and then into base assembly 202. In certain embodiments, there are two wire rings inside of pan 224 that enable two sets of wires to be separated, e.g. a low voltage wire and a 110V wire. The 2 separate inner wire paths lead to two separate conduit knockouts 228 or conduit paths. As illustrated, pan 224 is typically hexahedron shaped and is open at the top. Other shapes, such as a cylinder are also possible without departing from the scope of the invention.

As illustrated in FIGS. 1A and 1B, when modular mount 110 is fully assembled, a lid 230 covers and attaches to pan 224. Taken together, pan 224 and lid 230 are commonly referred to as a head 232, or a head assembly 232. Lid 230 attaches to pan 224 using screws, clips, or other means of attachment. Lid 230 is easily removeable allowing service personnel to access wiring.

Head 232 is fully weatherized. It has a water-impermeable coating and there are gaskets, typically rubber gaskets, between lid 230 and pan 224 that prevent water permeation.

For example, in certain embodiments a gasket is installed around the upper perimeter of pan 224 and lid 230 sits atop the gasket. This minimizes permeation of dust, water, and water vapor into the internal volume of head 232.

### Arm and Camera Assemblies

Arm assembly 240 attaches at the bottom of pan 224. Typically, when assembled and mounted, it descends from pan 224 downward in the Z direction towards the floor. Arm assembly 240 attaches to pan 224 via an upper coupler 241a which secures arm 242 to pan 224. At its lower end, arm assembly 240 attaches to a housing 252 of camera assembly 250 via a lower coupler 241b. Arm assembly 240 also includes a joint 244 that enables camera assembly 250 to move if it is impacted, e.g. if it is struck, knocked or pushed. If it is impacted, joint 244 enables arm assembly 240 to move in order to absorb the shock, and then self-aligns to its original, vertical, position. Thus, after impact, arm assembly 240 restores camera assembly 250 to its preferred, vertical, operating position, maintaining surveillance integrity. Joint 244 may be a high-tension spring, universal joint, double universal joint or other mechanism capable of supporting the size and weight of camera assembly 250 and which has the ability to move from a resting position after being struck and then return to its original position. In certain embodiments, coupler 241a and 241b are threaded couplers. The threading allows for fine tuning or readjustment of the camera assembly if needed.

Arm assembly 240 may be provided in various lengths. Typical lengths are 6 inches, 1 foot, 2 feet, 3 feet, etc.

In certain embodiments, arm assembly 242 includes an upper arm 242a that attaches to the bottom of pan 224 at its top end and couples with the top end of spring 244 at its lower end. Arm assembly 242 further includes a lower arm 242b that couples at its top end with joint 244 at its lower end with the top side of housing 252. An arm 242, upper arm 242a, or lower arm 242b is typically a pipe or tube, e.g. 1″ in diameter, made of plastic, aluminum, copper or another material. Wiring runs through the pipe.

Camera assembly 250 may be customized to fit various camera sizes. It includes a housing 252, which in certain embodiments has the shape of a square or rectangular box, although other shapes may be used. Housing 252 has a lid 254 that provides easy access to internal components. Housing 252 has a central pass-through for arm 242, ensuring all wiring is concealed and protected. The design of housing 252 allows for the mounting of additional devices like lights, bar code scanners and speakers. Housing 252 may be drilled with holes to enable attachments to various devices. Wiring emanating from camera 256 or any other mounted devices runs through the interior of arm 242.

In certain embodiments, each of the parts of modular mount 110 is made of metal that that is coated with an anti-rust treatment. In other embodiments, certain parts are made of plastic or another substance.

Although not depicted in FIG. 2A, in certain embodiments a safety cable connects pan 224 and camera assembly 250. In the event that a forklift or other device strikes camera assembly 250 with sufficient force to break the camera assembly 250 from pan 224, the safety cable will prevent camera assembly 250 from falling and potentially doing damage.

FIG. 2B is an isometric view of an embodiment of modular mount 110 in a disassembled state where lid 254 is open. Although not depicted, lid 254 typically includes a hinge or other opening mechanism.

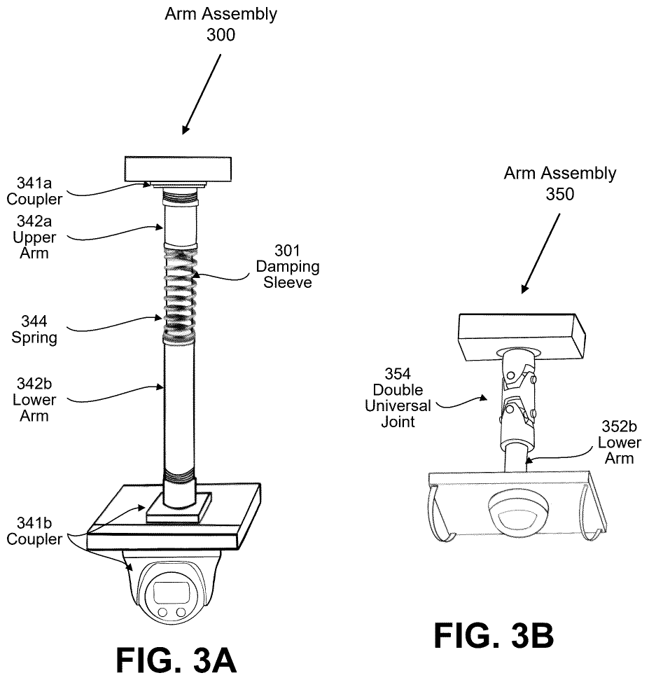

FIGS. 3A and 3B are embodiments of arm assembly 240. The principal difference between the two embodiments is that in arm assembly 300 joint 244 is implemented or embodied by spring 344, whereas in arm assembly 350 joint 244 is implemented using a double universal join 354.

FIG. 3A illustrates an arm assembly 300, which is an embodiment of arm assembly 240. Arm assembly 300 includes a spring 344, an upper arm 342a, a lower arm 342b, an upper coupler 341a and a lower coupler 341b. A damping sleeve 301 runs the length of arm assembly 300, inside spring 344 and lower arm 342b. Damping sleeve 301 dampens oscillation caused by an impact. Generally, damping sleeve 301 is made of polyurethane, rubber or another type of plastic. It is typically cylindrical in shape.

In one embodiment, upper arm 342a and lower arm 342b is a 1 inch diameter cylindrical metal pipe and spring 344 is a 1 inch diameter cylindrical metal extension spring. Dampening sleeve 301 is a ¾ inch diameter cylindrical tube that fits inside upper arm 342a, lower arm 342b and spring 344. Wiring runs along the inside of dampening sleeve 301.

FIG. 3B illustrates an arm assembly 350, which is another embodiment of arm assembly 240. Arm assembly 350 uses a double universal joint 354 to absorb shock and return to an original position. It attaches to a lower arm 352b. A variety of configurations of universal joints may be used to implement joint 244. For example, single, double, and triple universal joints are commercially available.

Upon reading this disclosure, those of skill in the art will appreciate that while particular embodiments and applications have been illustrated and described herein, the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A modular mount for mounting a camera and other equipment to a wall, comprising:
a base assembly, comprising:
a wall bracket used to attach the modular mount to a wall, and
a primary tube, attached to the wall bracket; and
a head assembly, comprising:
a secondary tube, with two ends, wherein the first end fastens to the primary tube; and
a head, attached to the second end of the secondary tube, comprising:
a pan attached to the secondary tube; and
a lid that seals the pan;
an arm assembly attached to the underside of the pan which projects vertically downward from the pan, comprising:
an upper coupler that attaches the arm assembly to the underside of the pan;
an arm that drops downward from the pan; and
a lower coupler that attaches the arm assembly to a camera assembly; and
a camera assembly, comprising:
a housing that attaches to the lower coupler, to which a camera and any other equipment mounts.

2. The modular mount of claim 1, wherein:
the arm assembly further comprises a joint that enables the camera assembly (1) to move if it is struck, and (2) to then to return to its original position.

3. The modular mount of claim 2, wherein:
the joint is a spring, a universal joint, or a hinge.

4. The modular mount of claim 2, wherein:
the arm assembly further comprises an upper arm and a lower arm, and wherein the joint is positioned between the upper arm and lower arm.

5. The modular mount of claim 2, wherein the arm and the joint are cylindrical in shape and a cylindrical damping sleeve is positioned inside the arm and the joint.

6. The modular mount of claim 5, wherein wiring from the camera and any other equipment that mounts to the housing runs vertically upward through the damping sleeve to the pan.

7. The modular mount of claim 1, wherein the primary tube is L-shaped and comprises:
a 1^{st} part that attaches to the wall bracket and, when the modular mount is mounted on the wall, extends perpendicular to the wall, and a 2^{nd} part connected to the 1^{st} part, which forms a 90 degree angle with the first part.

8. The modular mount of claim 3 wherein the secondary tube fits inside of or outside of the 2^{nd} part of the primary tube and the secondary tube and the primary tube are fastened by aligning pre-drilled holes in each of the two tubes and inserting fasteners through the pre-drilled holes.

9. The modular mount of claim 1, wherein when the head is in the shape of a hexahedron.

10. The modular mount of claim 1, wherein a gasket is fitted to the upper perimeter of the pan the lid fits on top of the gasket.

11. The modular mount of claim 1, wherein the secondary tube comprises a conduit that may be used to separate electrical wires.
